(19) United States
(12) Patent Application Publication
(10) Pub. No.: US 2017/0179595 A1
(43) Pub. Date: Jun. 22, 2017

(54) BASE STATION AND COMMUNICATION CONTROL METHOD

(71) Applicant: FUJITSU LIMITED, Kawasaki-shi (JP)

(72) Inventors: DAISUKE OGAWA, Yokosuka (JP); Kazuo Nagatani, Yokohama (JP); TOMONORI SATO, Kawasaki (JP)

(73) Assignee: FUJITSU LIMITED, Kawasaki-shi (JP)

(21) Appl. No.: 15/376,954

(22) Filed: Dec. 13, 2016

(30) Foreign Application Priority Data
Dec. 16, 2015 (JP) 2015-245036
Oct. 14, 2016 (JP) 2016-203009

(51) Int. Cl. H01Q 3/34; H04W 16/28

(52) U.S. Cl. CPC H01Q 3/34; H04W 16/28

(57) ABSTRACT

A base station including: a memory, and a processor coupled to the memory and the processor configured to: estimate a plurality of angles of arrival based on a plurality of received signals from a plurality of wireless device respectively, each of the plurality of angles of arrival being an angel of a horizontal plane relative to each direction from which each of the plurality of received signals arrives, and control at least one tilt angel based on the plurality of angels of arrival, each of the at least one tilt angle being an angle of the horizontal plane relative to each direction to which at least one beam is formed.

### CROSS-REFERENCE TO RELATED APPLICATION

This application is based upon and claims the benefit of priority of the prior Japanese Patent Applications No. 2015-245036, filed on Dec. 16, 2015, and No. 2016-203009, filed on Oct. 14, 2016, the entire contents of which are incorporated herein by reference.

### FIELD

The embodiment discussed herein is related to a base station and a communication control method.

### BACKGROUND

A base station device that forms a beam by using a beam forming technology and that wirelessly communicates by using the formed beam is known (see, for example, Japanese Laid-open Patent Publication No. 2013-211716 and “3rd Generation Partnership Project; Technical Specification Group Radio Access Network; Study of Radio Frequency (RF) and Electromagnetic Compatibility (EMC) requirements for Active Antenna Array System (AAS) base station (Release 12)”, 3GPP TR 37. 840, version 12. 1. 0, January 2014). A base station device uses a plurality of beams to form a plurality of respective wireless areas that can wirelessly communicate with each other. The base station device controls the tilt angle, which is the angle of a beam relative to a horizontal plane, based on the number of wireless devices located in the plurality of wireless areas formed by the base station device.

### SUMMARY

According to an aspect of the invention, a base station includes a memory, and a processor coupled to the memory and the processor configured to: estimate a plurality of angles of arrival based on a plurality of received signals from a plurality of wireless device respectively, each of the plurality of angles of arrival being an angel of a horizontal plane relative to each direction from which each of the plurality of received signals arrives, and control at least one tilt angel based on the plurality of angels of arrival, each of the at least one tilt angle being an angle of the horizontal plane relative to each direction to which at least one beam is formed.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a relationship between wireless areas formed by a base station device and positions of wireless devices;

FIG. 2 is a block diagram illustrating an example of a configuration of a wireless communication system of an embodiment;

FIG. 3 is a block diagram illustrating an example of a configuration of a base station device of FIG. 2;

FIG. 4 is a block diagram illustrating an example of a configuration of a vertical direction cell group processor of FIG. 3;

FIG. 5 is a block diagram illustrating an example of a configuration of a horizontal direction cell antenna unit of FIG. 3;

FIG. 6 is a block diagram illustrating an example of a configuration of a vertical direction weight control unit of FIG. 5;

FIG. 7 is a graph illustrating an example of received power characteristics representing a change in received power of the base station device with respect to an angle on a vertical plane;

FIG. 8 is a diagram illustrating an example of an angle of a direction in the vertical plane relative to a horizontal plane;

FIG. 9 is a diagram illustrating an example of a relationship between wireless areas formed by the base station device of FIG. 2 and positions of wireless devices; and

FIG. 10 is a graph illustrating an example of received power characteristics corrected by a base station device of a third modified example of the embodiment.

FIG. 11 is a flowchart illustrating an example of an angle of arrival estimation process performed by the base station device of the third modified example of the embodiment;

FIG. 12 is a graph illustrating a first example of an angle of arrival estimation process performed by the base station device of a fourth modified example of the embodiment;

FIG. 13 is a graph illustrating a second example of an angle of arrival estimation process performed by the base station device of a fourth modified example of the embodiment;

FIG. 14 is a graph illustrating an example of the centroid position of received power; and

FIG. 15 is a flowchart illustrating an example of an angle of arrival estimation process performed by the base station device of the fourth modified example of the embodiment.

### DESCRIPTION OF EMBODIMENTS

For example, the base station device described above controls the tilt angle of each beam such that the number of wireless devices located in each of a plurality of wireless areas formed by the base station device is the same across the wireless areas.

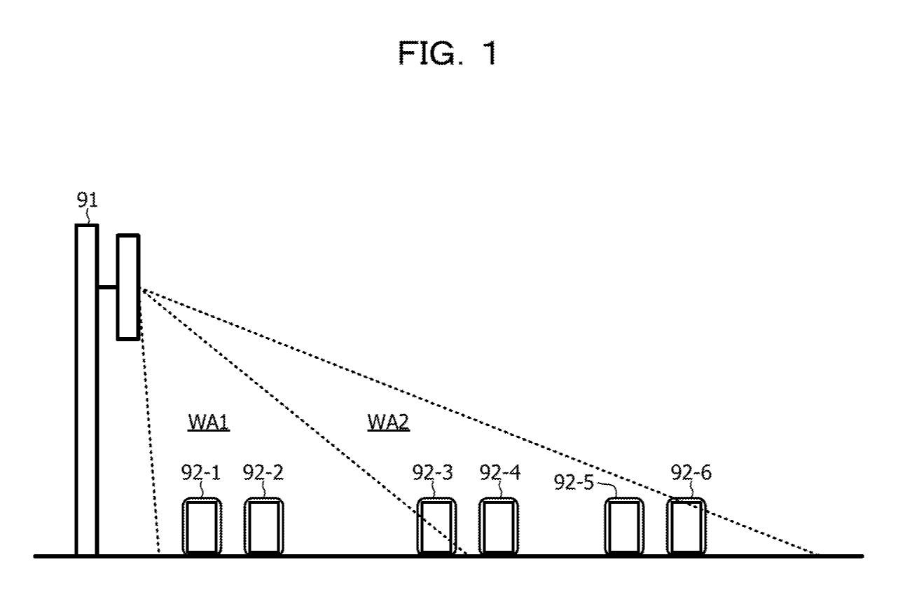

For example, as illustrated in FIG. 1, let us assume that the base station device 91 forms two wireless areas WA1 and WA2, and six wireless devices 92-1 to 92-6 are located in the two wireless areas WA1 and WA2. Furthermore, six wireless devices 92-1 to 92-6 are located from the nearest to to the farthest from the base station device 91, and the wireless device 92-3 and the wireless device 92-4 are close to each other.

In this case, the base station device 91 controls tilt angles of respective beams such that three wireless devices of the wireless devices 92-1 to 92-6 are located in each of the wireless areas WA1 and WA2. Therefore, the boundary between the wireless area WA1 and the wireless area WA2 is located between the wireless device 92-3 and the wireless device 92-4. In this case, radio signals between the wireless areas WA1 and WA2 may interfere resulting in a decrease in the communication quality in the wireless device 92-3 and the wireless device 92-4.

In one aspect, one of the goals of the present embodiment is to enhance the communication quality.

The embodiment will be described below with reference to the drawings. Note that, the embodiment described below is an example. Thus, application of various modifications and/or techniques that are not explicitly described below to the embodiment is not excluded. Note that, in the drawings used in the following embodiment, elements labeled with the same reference numeral represent the same or similar elements unless a change or a modification is explicitly stated.

### Embodiments

Configuration

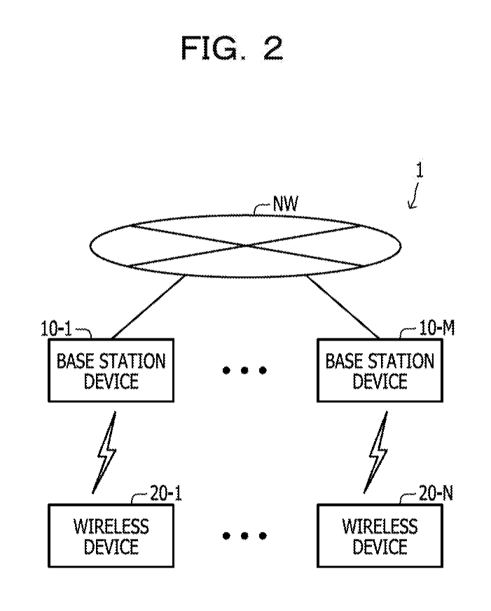

For example, as illustrated in FIG. 2, a wireless communication system 1 according to the embodiment has M base station devices 10-1, . . . , 10-M and N wireless devices 20-1, . . . , 20-N.

In this example, the number M is a positive integer. Further, in the following description, a base station device 10-m may be denoted as a base station device 10 when not distinguished from another base station device. The number m is any integer from 1 to M. In this example, the number N is an integer greater than or equal to 2. Further, in the following description, individual wireless devices 20-n may be denoted as a wireless device 20 when not distinguished from another wireless device. The number n is any integer from 1 to N.

The wireless communication system 1 performs a wireless communication conforming to a predetermined communication system between the base station device 10-m and the wireless device 20-n. For example, the communication system may be an LTE system. LTE stands for Long-Term Evolution. Note that the communication system may be a different system from the LTE system (for example, the LTE-Advance system or the like). Furthermore, the communication system in this example is a Time Division Duplex (TDD) system.

The base station device 10-m forms wireless areas by forming beams by using a beam forming technology. It can be understood that formation of a beam has the same meaning as transmission of a radio signal by the base station device 10-m such that received power when the radio signal is received by one wireless device 20 located in a particular direction becomes larger than received power when the radio signal is received by another wireless device 20 located in another direction. Further, it can be understood that formation of a beam has the same meaning as reception of a radio signal by the base station device 10-m such that received power when the radio signal is transmitted by one wireless device 20 located in a particular direction becomes larger than received power when the radio signal is transmitted by another wireless device 20 located in another direction.

In this example, the base station device 10-m has a plurality of antenna elements and uses the plurality of antenna elements to form beams, as described later.

In this example, the base station device 10-m forms a plurality of beams to form a plurality of wireless areas, respectively. A wireless area may be referred to as a coverage area or a communication area. Further, a wireless area may be referred to as a cell. For example, a cell may be a macro-cell, a micro-cell, a nano-cell, a pico-cell, a femto-cell, a home-cell, a small-cell, a sector-cell, or the like.

The base station device 10-m wirelessly communicates with the wireless device 20-n located within a cell formed by the base station device 10-m.

In this example, the base station device 10-m provides wireless resources in a cell formed by the base station device 10-m.

In this example, wireless resources are identified by the time and the frequency. In this example, a wireless resource associated with the time of one OFDM symbol of one OFDM subcarrier is referred to as a resource element (RE). OFDM stands for Orthogonal Frequency-Division Multiplexing. In other words, wireless resources include a plurality of REs having different combinations of time and frequency.

The base station device 10-m communicates with the wireless device 20-n located within a cell formed by the base station device 10-m by using wireless resources provided by the cell.

Note that the base station device 10-m may be called, for example, a base station, an evolved Node B (eNB), or a Node B (NB).

In this example, as illustrated in FIG. 2, the base station device 10-m m is connected to a communication network NW (for example, a core network). An interface between the base station device 10-m and the communication network NW may be called, for example, an S1-interface. Further, an interface between base station devices 10 may be called, for example, an X2-interface.

A section in the side of the communication network NW (that is, an upper level) of the base station device 10 of the wireless communication system 1 may be called, for example, an EPC. EPC stands for Evolved Packet Core. A section formed by the base station devices 10 of the wireless communication system 1 may be called, for example, E-UTRAN. E-UTRAN stands for Evolved Universal Terrestrial Radio Access Network.

The wireless device 20-n uses wireless resources provided in a cell where the wireless device 20-n is located and communicates with the base station device 10-m which forms the cell.

In this example, the wireless device 20-n is connected to the base station device 10-m by transmitting and receiving predetermined control signals to and from the base station device 10-m which forms a cell where the wireless device 20-n is located. Furthermore, in this example, when connected to the base station device 10-m, the wireless device 20-n transmits and receives data signals to and from the base station device 10-m.

Note that the wireless device 20-n may be called, for example, a mobile station device, a wireless terminal, a wireless device, a terminal device, or a user terminal (User Equipment (UE)). In this example, the wireless device 20-n may be a Machine to Machine (M2M) device, a mobile phone, or the like. An example of a mobile phone is a smartphone. An example of an M2M device is a sensor or a meter (a measuring instrument). An M2M device may be called, for example, an Internet of Things (IoT) device.

The wireless device 20-n may be carried by a user, mounted on a mobile unit such as a vehicle, or fixed in place.

Next, a configuration of the base station device 10-m will be further described.

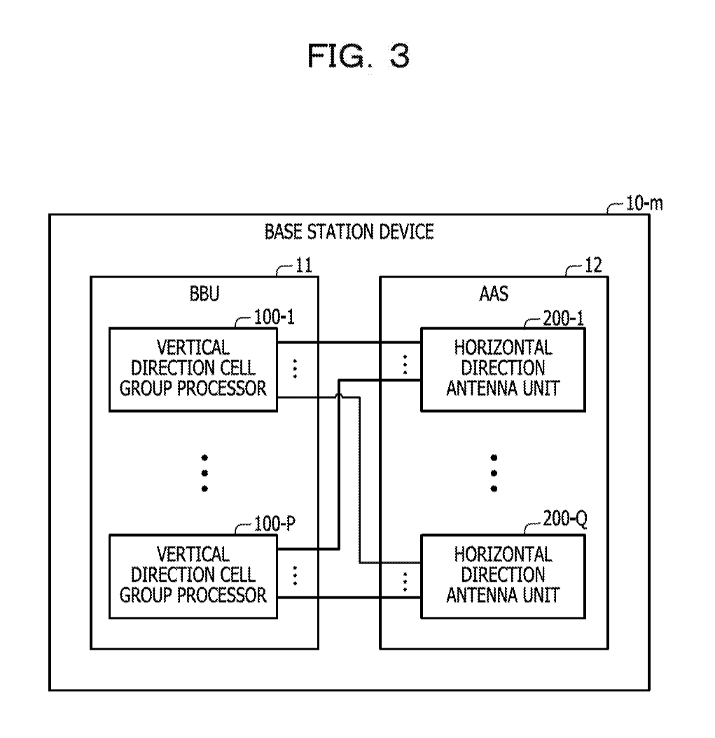

For example, as illustrated in FIG. 3, the base station device 10-m has a BBU 11 and an AAS 12. BBU stands for Baseband Unit. AAS stands for Active Antenna System.

The BBU 11 has P vertical direction cell group processors 100-1, . . . , 100-P. In this example, the number P is a positive integer. Further, in the following description, a vertical direction cell group processor 100-p may be referred to as a vertical direction cell group processor 100 when not distinguished from another vertical direction cell group processor. The number p is any integer from 1 to P.

The AAS 12 has Q horizontal direction antenna units 200-1, . . . , 200-Q. In this example, the number Q is a positive integer. Further, in the following description, a horizontal direction antenna unit 200-q may be referred to as a horizontal direction antenna unit 200 when not distinguished from another horizontal direction antenna unit. The number q is any integer from 1 to Q.

Each of the P vertical direction cell group processors 100-1, . . . , 100-P is connected to each of the Q horizontal direction antenna units 200-1, . . . , 200-Q. For example, the connection between the BBU 11 and the AAS 12 may conform with the Common Public Radio Interface (CPRI). In this example, the BBU 11 and the AAS 12 are connected via an optical fiber cable.

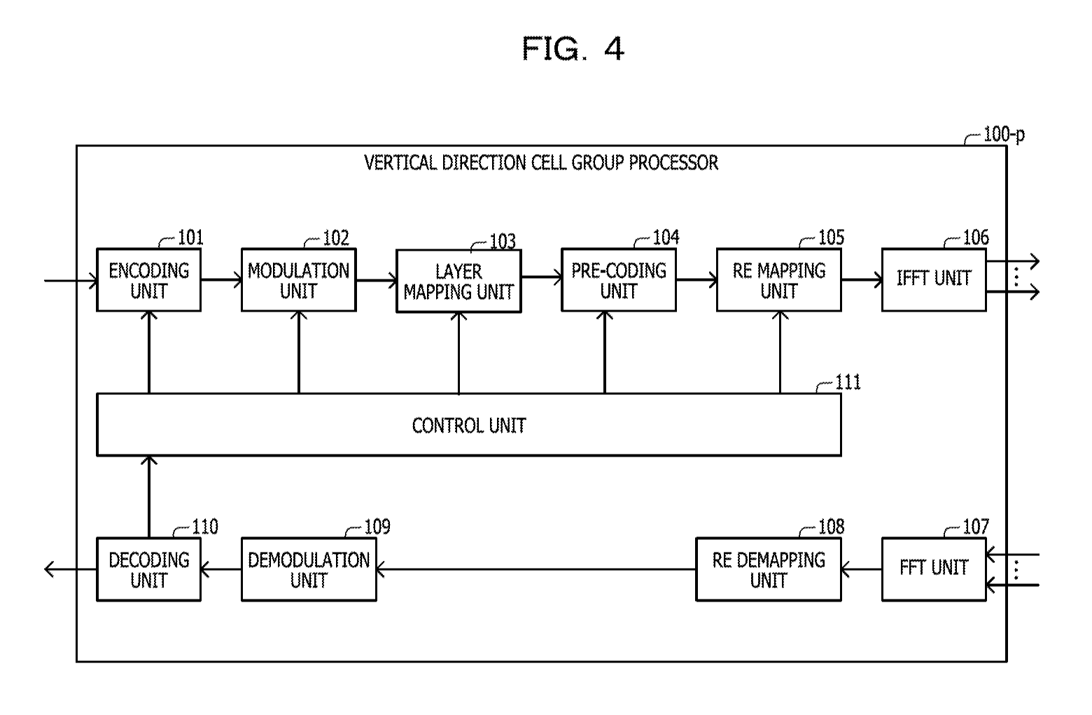

For example, as illustrated in FIG. 4, the vertical direction cell group processor 100-p has an encoding unit 101, a modulation unit 102, a layer mapping unit 103, a pre-coding unit 104, an RE mapping unit 105, and an IFFT unit 106. Furthermore, the vertical direction cell group processor 100-p has an FFT unit 107, an RE demapping unit 108, a demodulation unit 109, a decoding unit 110, and a control unit 111. IFFT stands for Inverse Fast Fourier Transform. FFT stands for Fast Fourier Transform.

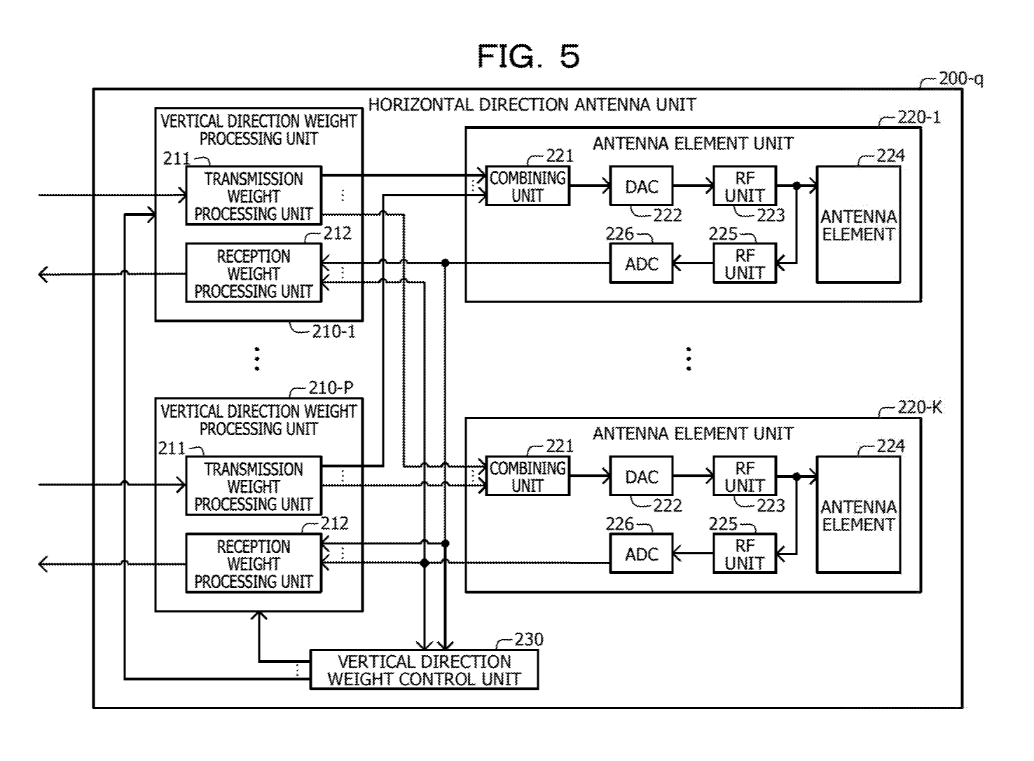

For example, as illustrated in FIG. 5, the horizontal direction antenna unit 200-q has P vertical direction weight processing units 210-1, . . . , 210-P, K antenna element units 220-1, . . . , 220-K and a vertical direction weight control unit 230. In the following description, a vertical direction weight processing unit 210-p may be referred to as a vertical direction weight processing unit 210 when not distinguished from another vertical direction weight processing unit. In this example, the number K is a positive integer. Further, in the following description, an antenna element unit 220-k may be referred to as an antenna element unit 220 when not distinguished from another antenna element unit. The number k is any integer from 1 to K.

The vertical direction weight processing unit 210-p has a transmission weight processing unit 211 and a reception weight processing unit 212.

The antenna element unit 220-k has a combining unit 221, a DAC 222, an RF unit 223, an antenna element 224, an RF unit 225, and an ADC 226. DAC stands for Digital to Analog Converter. RF stands for Radio Frequency. ADC stands for Analog to Digital Converter.

In this example, each of the Q horizontal direction antenna units 200-1, . . . , 200-Q has a different position on a horizontal plane of the K antenna element units 220-1, . . . , 220-K. Further, in this example, in the Q horizontal direction antenna units 200-1, . . . , 200-Q, the vertical positions of the K antenna element units 220-1, . . . , 220-K are common to each other.

In this example, each of the antenna elements 224 of the K antenna element units 220-1, . . . , 220-K of the horizontal direction antenna unit 200-q has a different vertical position.

Note that, in the AAS 12, a section of the antenna elements 224 of the AAS 12 and a section other than the antenna elements 224 of the AAS 12 may be formed as separate members. In this case, the section other than the antenna elements 224 of the AAS 12 may be called, for example, a Remote Radio Head (RRH).

First, in a configuration of the base station device 10-m, sections related to transmission of a radio signal will be described.

Transmission data is input into the encoding unit 101. In this example, transmission data includes user data and control data. For example, user data is data used for services provided to a user of the wireless device 20-n, and control data is data used for control of communications between the base station device 10-m and the wireless device 20-n.

The encoding unit 101 performs an encoding process on input transmission data. The encoding process includes encoding using an error correction code. For example, an error correction code is a convolutional code, a turbo code, a Low-Density Parity-Check Code (LDPC), or the like. The encoding unit 101 outputs the encoded transmission data to the modulation unit 102.

The modulation unit 102 performs a modulation process on transmission data input from the encoding unit 101. The modulation process includes modulation conforming to a predetermined modulation system. For example, a modulation system is a QPSK, 16QAM, 64QAM, or the like. QPSK stands for Quadrature Phase Shift Keying. QAM stands for Quadrature Amplitude Modulation. The modulation unit 102 outputs the modulated transmission data to the layer mapping unit 103.

The layer mapping unit 103 allocates transmission data input from the modulation unit 102 to a plurality of streams (or layers) in MIMO. MIMO stands for Multiple Input Multiple Output. Allocation of transmission data may be referred to as mapping of transmission data. The layer mapping unit 103 outputs transmission data allocated to each stream to the pre-coding unit 104.

The pre-coding unit 104 performs a weighting process on transmission data input from the layer mapping unit 103. The weighting process performed by the pre-coding unit 104 may be referred to as a pre-coding process. In this example, a weighting process performed by the pre-coding unit 104 includes a process of applying a weighting to transmission data for each of the horizontal direction antenna units 200. In this example, a weighting process performed by the pre-coding unit 104 includes multiplying transmission data by a weight coefficient.

In this example, a weighting process performed by the pre-coding unit 104 corresponds to amplitude and phase control of a radio signal. The weighting process performed by the pre-coding unit 104 is an example of controlling beam direction in the horizontal direction. The pre-coding unit 104 outputs the weighted transmission data to the RE mapping unit 105.

The RE mapping unit 105 allocates transmission data input from the pre-coding unit 104 and a predetermined reference signal to an RE included in wireless resources. The RE mapping unit 105 outputs to the IFFT unit 106 a signal to which transmission data and a reference signal are allocated.

The IFFT unit 106 applies an IFFT to a signal input from the RE mapping unit 105 to convert the signal from a frequency domain signal to a time domain signal. In addition, the IFFT unit 106 adds a cyclic prefix (CP) to the converted signal. The IFFT unit 106 outputs, to the Q horizontal direction antenna units 200-1, . . . , 200-Q, the signal to which the CP has been added.

A signal output from the IFFT unit 106 of the vertical direction cell group processor 100-p of FIG. 4 is input into a transmission weight processing unit 211 of the vertical direction weight processing unit 210-p of the horizontal direction antenna unit 200-q of FIG. 5. Each of the transmission weight processing units 211 performs a weighting process on the input signal. In this example, a weighting process performed by each of the transmission weight processing units 211 includes a process of applying a weighting to a signal input from the IFFT unit 106 for each of the antenna element units 220.

In this example, a weighting process performed by each of the transmission processing units 211 includes multiplying signals by weight coefficients. As described later, weight coefficients used by the transmission weight processing units 211 are determined by the vertical direction weight control unit 230.

In this example, a weighting process performed by each of the transmission weight processing units 211 corresponds to amplitude and phase control of a radio signal. The weighting process performed by each of the transmission weight processing units 211 is an example of controlling a beam direction in the vertical direction. Each of the transmission weight processing units 211 outputs the weighted signal to the combining units 221 of the K antenna element units 220-1, . . . , 220-K.

In this example, each of the transmission weight processing units 211 of the P vertical direction weight processing units 210-1, . . . , 210-P uses different weight coefficients. Thereby, P beams having different tilt angles in the vertical plane are formed. A tilt angle is an angle of a beam direction relative to the horizontal plane.

Formation of a plurality of cells by a plurality of respective beams whose tilt angles are different from each other may be called, for example, Vertical Sectorlization (VS).

For example, when P is 2, a cell formed by a beam having a smaller tilt angle may be called, for example, an outer cell, and a cell formed by a beam having a larger tilt angle may be called, for example, an inner cell.

The combining unit 221 combines signals input from the transmission weight processing units 211 of the P vertical direction weight processing units 210-1, . . . , 210-P. The combining unit 221 outputs the combined signal to the DAC 222.

The DAC 222 converts a signal input from the combining unit 221 from a digital signal to an analog signal. The DAC 222 outputs the converted signal to the RF unit 223.

The RF unit 223 applies, to a signal input from the DAC 222, frequency conversion (up-conversion in this example) from a baseband to a radio frequency band. The RF unit 223 amplifies the frequency-converted signal and transmits the amplified signal as a radio signal via the antenna element 224.

Next, in the configuration of the base station device 10-m, sections related to reception of a radio signal will be described.

The RF unit 225 receives a radio signal transmitted by the wireless device 20-n via the antenna element 224. The RF unit 225 amplifies the received radio signal. In this example, the RF unit 225 performs amplification by using a low noise amplifier (LNA). The RF unit 225 applies, to the amplified signal, frequency conversion (down-conversion in this example) from a radio frequency band to a baseband. The RF unit 225 outputs the frequency-converted signal to the ADC 226.

The ADC 226 converts a signal input from the RF unit 225 from an analog signal to a digital signal. The ADC 226 outputs the converted signal to each of the reception weight processing units 212 of the P vertical direction weight processing units 210-1, . . . 210-P and to the vertical direction weight control unit 230.

Signals from each of the ADCs 226 of the K antenna element units 220-1, . . . , 220-K are input into the reception weight processing unit 212. The reception weight processing unit 212 performs a weighting process on the input signals. In this example, a weighting process performed by the reception weight processing unit 212 includes a process of applying a weighting to signals input from the ADCs 226 of the K antenna element units 220-1, . . . , 220-K for each of the antenna element units 220.

In this example, a weighting process performed by the reception weight processing unit 212 includes multiplying signals by weight coefficients. As described later, weight coefficients used by the reception weight processing units 212 are determined by the vertical direction weight control unit 230.

In this example, a weighting process performed by each of the reception weight processing units 212 corresponds to amplitude and phase control of a radio signal. The weighting process performed by the reception weight processing unit 212 is an example of controlling beam direction in the vertical direction. The reception weight processing unit 212 of the vertical direction weight processing unit 210-p combines the weighted signals and outputs the combined signal to the FFT unit 107 of the vertical direction cell group processor 100-p.

In this example, among the vertical direction weight processing units 210, the reception weight processing units 212 of the P vertical direction weight processing units 210-1, . . . , 210-P use different weight coefficients. Thereby, P beams having different tilt angles in the vertical plane are formed. A tilt angle is an angle of a beam direction relative to the horizontal plane.

The FFT unit 107 of the vertical direction cell group processor 100-p removes the CP from signals input from the reception weight processing units 212 of the vertical direction weight processing units 210-p of the Q horizontal direction antenna units 200-1, . . . , 200-Q. The FFT unit 107 converts a time domain signal into a frequency domain signal by applying an FFT to the signal in which the CP has been removed. The FFT unit 107 outputs the converted signal to the RE demapping unit 108.

The RE demapping unit 108 extracts, from a signal input from the FFT unit 107, a portion to which user data, control data, and a reference signal are allocated. The RE demapping unit 108 outputs the extracted signals corresponding to the user data, the control data, and the reference signal, respectively, to the demodulation unit 109.

The demodulation unit 109 estimates a transmission path based on a signal corresponding to a reference signal input from the RE demapping unit 108. The demodulation unit 109 performs a demodulation process on signals corresponding to user data and control data based on the estimated transmission path and the signal corresponding to the user data and the control data input from the RE demapping unit 108. A modulation process includes modulation corresponding to the modulation systems described above. The modulation unit 109 outputs the modulated signal to the decoding unit 110.

The decoding unit 110 performs an error correction process based on an error correction code to a signal input from the demodulation unit 109. The decoding unit 110 outputs received data represented by the decoded signal. For example, user data of the received data output from the decoding unit 110 is transmitted to a device different from the base station device 10-m (in other words, an upper level device) via the communication network NW. In this example, control data of the received data output from the decoding unit 110 is output to the control unit 111.

The control unit 111 controls the encoding unit 101, the modulation unit 102, the layer mapping unit 103, the pre-coding unit 104, and the RE demapping unit 105 based on control data input from the decoding unit 110. At least one of the coding rate used for an encoding process and the modulation system used for a modulation process, the number of layers in MIMO, weight coefficients used for a pre-coding process, and allocation of REs to transmission data and a control signal may be controlled for each wireless device 20.

In this example, functions of the base station device 10-m are implemented by Large Scale Integration (LSI). Note that functions of the base station device 10-m may be implemented by a Programmable Logic Device (PLD). Further, the base station device 10-m may have a processing device and a storage device, and functions thereof may be implemented when the processing device executes a program stored in the storage device.

For example, the processing device may be a central processing unit (CPU) or a digital signal processor (DSP), and the storage device may be at least one of RAM, ROM, a HDD, an SSD, semiconductor memory, and an organic memory. RAM stands for Random Access Memory. ROM stands for Read Only Memory. HDD stands for Hard Disk Drive. SSD stands for Solid State Drive. Further, for example, the storage device may include a floppy disk, an optical disk, a magneto-optical disk, or a storage medium such as semiconductor memory and a reading device that is able to read information from the storage medium.

The vertical direction weight control unit 230 will be further described.

As described above, the communication system is the TDD system in this example. Therefore, communication from the wireless device 20-n to the base station device 10-m (that is, an uplink communication) and communication from the base station device 10-m to the wireless device 20-n (that is, a downlink communication) use the same radio frequency. In other words, a transmission path between the base station device 10-m and the wireless device 20-n is common to both uplink communication and downlink communication.

In this example, the base station device 10-m controls the tilt angle of a beam based on an uplink communication signal (that is, a signal received from the wireless device 20-n).

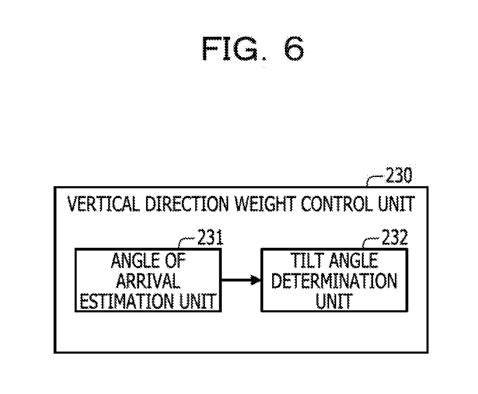

For example, as illustrated in FIG. 6, the vertical direction weight control unit 230 has an angle of arrival estimation unit 231 and a tilt angle determination unit 232. The angle of arrival estimation unit 231 is an example of an estimation unit. The tilt angle determination unit 232 is an example of a control unit.

Signals output from the ADCs 226 of the K antenna element units 220-1, . . . , 220-K is input into the angle of arrival estimation unit 231. The angle of arrival estimation unit 231 uses, for example, a beamformer technology, a linear prediction technology, a minimum norm technology, a MUSIC technology, an ESPRIT technology, or the like to acquire received power characteristics.

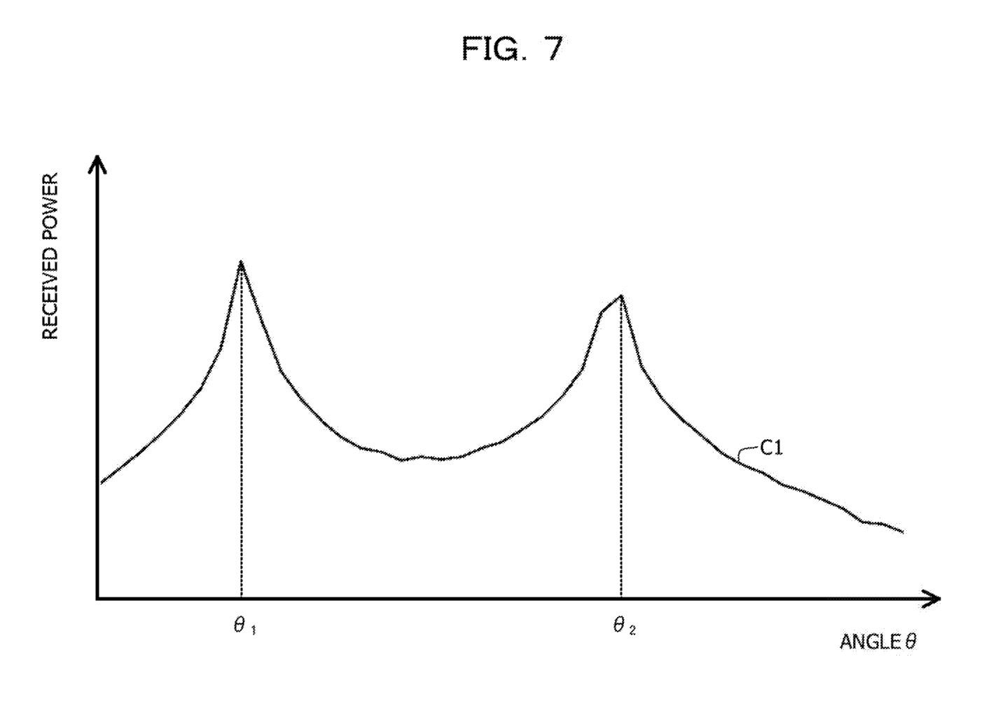

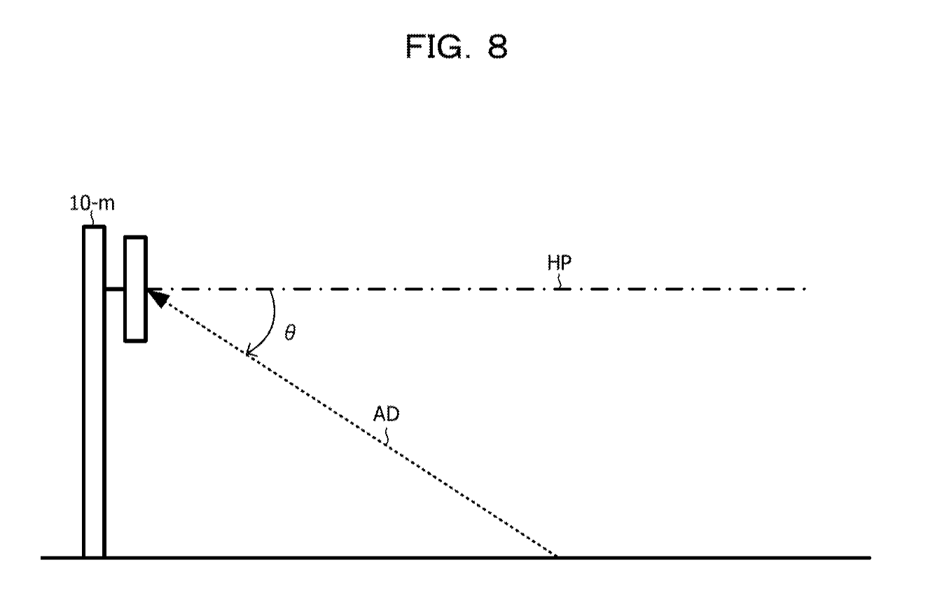

For example, as illustrated in FIG. 7, received power characteristics Cl represent a relationship between signals received by the base station device 10-m from the N wireless devices 20-1, . . . , 20-N in a direction in the vertical plane and an angle e of the direction relative to the horizontal plane. For example, as illustrated in FIG. 8, the angle e is an angle of a direction AD in the vertical plane relative to a horizontal plane HP. In this example, received power of a signal received in a certain direction is the received power of the signal received by using a beam in the direction.

It can be understood that the received power characteristics C1 represent a change in the received power of signals received by the base station device 10-m from the N wireless devices 20-1, . . . , 20-N in the direction in the vertical plane with respect to the angle e of a direction relative to the horizontal plane.

MUSIC stands for Multiple Signal Classification. ESPRIT stands for Estimation of Signal Parameters via Rotational Invariance Techniques.

The angle of arrival estimation unit 231 estimates an angle of arrival based on the acquired received power characteristics. An angle of arrival is an angle of the horizontal plane relative to a direction from which a signal received by the base station device 10-m from each of the N wireless devices 20-1, . . . , 20-N.

Note that the angle of arrival estimation unit 231 may extract, from an input signal, signals received from each of the N wireless devices 20-1, . . . , 20-N and estimate an angle of arrival for each wireless device 20 based on the extracted signals.

The tilt angle determination unit 232 determines P tilt angles that are different from each other based on the angles of arrival estimated by the angle of arrival estimation unit 231. The tilt angle determination unit 232 determines weight coefficients used by the P vertical direction weight processing units 210-1, . . . , 210-P based on the determined tilt angles.

For example, as illustrated in FIG. 7, let us assume that received power characteristics have maximum values (or peaks) of received power at a first angle θ₁ and a second angle θ₂, respectively, and P is 2. In this case, the tilt angle determination unit 232 determines the first angle θ₁ as a tilt angle for the vertical direction weight processing unit 210-1 and determines the second angle θ₂ as a tilt angle for the vertical direction weight processing unit 210-2.

Operation

An example of the operation of the wireless communication system 1 will be described.

The base station device 10-m receives signals wirelessly from the N wireless devices 20-1, . . . , 20-N. The base station device 10-m acquires received power characteristics based on the signals received from the N wireless devices 20-1, . . . , 20-N.

The base station device 10-m determines P tilt angles that are different from each other based on the acquired received power characteristics. The base station device 10-m determines weight coefficients used by the P vertical direction weight processing units 210-1, . . . , 210-P based on the determined tilt angles. The base station device 10-m uses the determined weight coefficients to form a plurality of beams and thereby forms a plurality of cells, respectively.

The wireless device 20-n uses wireless resources provided in at least one cell of the plurality of cells formed by the base station device 10-m to wirelessly communicate with this base station device 10-m.

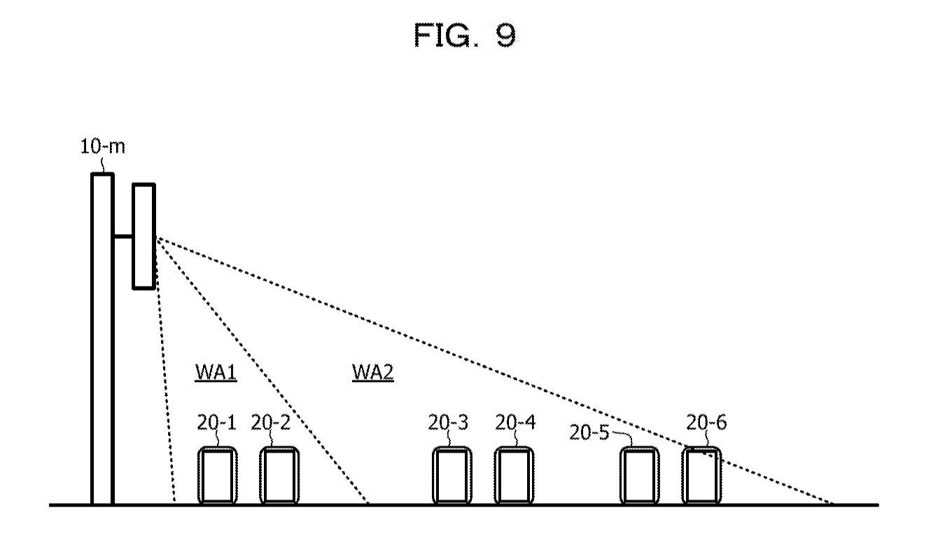

For example, as illustrated in FIG. 9, let us assume that the base station device 10-m forms two wireless areas WA1 and WA2, and six wireless devices 20-1, . . . , 20-6 are located in the two wireless areas WA1 and WA2. Furthermore, six wireless devices 20-1, . . . , 20-6 are located from the nearest to to the farthest from the base station device 10-m, and the wireless device 20-3 and the wireless device 20-4 are close to each other.

In this case, the base station device 10-m controls tilt angles of respective beams such that the wireless area WA1 covers the wireless devices 20-1 and 20-2 and the wireless area WA2 covers the wireless devices 20-3 to 20-6. Therefore, the boundary of the wireless area WA1 and the wireless area WA2 is located between the wireless device 20-2 and the wireless device 20-3. In this case, in the wireless device 20-2 and the wireless device 20-3, interference of radio signals between the two wireless areas WA1 and WA2 can be suppressed. This can enhance the communication quality.

As described above, the base station device 10-m of the embodiment forms beams and performs a wireless communication by using the formed beams. Furthermore, based on each of signals received from the plurality of wireless devices 20-1, . . . , 20-N, the base station device 10-m estimates the angle of arrival, which is an angle of an arrival direction of the signal relative to the horizontal plane. In addition, the base station device 10-m controls the tilt angle, which is an angle of a beam direction relative to the horizontal direction, based on the estimated angle of arrival.

This allows a beam to be formed in a direction toward an area where the plurality of wireless devices 20-1, . . . , 20-N are densely located. This can reduce the probability of a boundary between wireless areas (cells in this example) being located in an area where the plurality of wireless devices 20-1, . . . , 20-N are densely located. Thereby, an interference of radio signals between wireless areas can be suppressed. As a result, the communication quality can be enhanced.

Furthermore, the base station device 10-m of the embodiment estimates an angle of arrival based on a change in received power of signals received from the plurality of wireless devices 20-1, . . . , 20-N in a certain direction with respect to an angle of this direction relative to the horizontal plane.

This allows for estimation of an angle of arrival that accurately reflects an angle of the horizontal plane relative to a direction toward an area where the plurality of wireless devices 20-1, . . . , 20-N are densely located.

Furthermore, in the base station device 10-m of the embodiment, the BBU 11 and the AAS 12 are connected via a cable.

Let us assume a case where the P vertical direction weight processing units 210-1, . . . , 210-P and the vertical direction weight control unit 230 were included in the BBU 11 instead of the AAS 12. In this case, connection of each of the P vertical direction weight processing unit 210-1, . . . , 210-P to each of the K antenna element unit 220-1, . . . , 220-K would result in an increase of the number of cables. In contrast, according to the base station device 10-m of the embodiment, the AAS 12 includes the P vertical direction weight processing units 210-1, . . . , 210-P and the vertical direction weight control unit 230. In other words, the AAS 12 autonomously controls a tilt angle. This can suppress an increase in the number of cables.

### First Modified Example of the Embodiment

Next, a base station device of the first modified example of the embodiment will be described. The base station device of the first modified example of the embodiment is different from the base station device of the embodiment in that a tilt angle is controlled based on a difference between angles of arrival. This difference will be mainly described below. Note that, in the description of the first modified example of the embodiment, elements labeled with the same reference numerals as those in the embodiment represent the same or substantially the same elements as illustrated in the embodiment.

The angle of arrival estimation unit 231 of the first modified example of the embodiment estimates P angles of arrival different from each other based on the acquired received power characteristics. In this example, the number P is an integer greater than or equal to 2. For example, the angle of arrival estimation unit 231 acquires P angles at which received power is the maximum in the acquired received power characteristics in the order from an angle of the greater maximum value and estimates the acquired P angles as P angles of arrival, respectively.

The tilt angle determination unit 232 of the first modified example of the embodiment determines whether or not a difference between angles of arrival of P angles of arrival estimated by the angle of arrival estimation unit 231 is smaller than a predetermined threshold.

When the difference is smaller than the threshold, the tilt angle determination unit 232 determines P predetermined reference angles that are different from each other as P tilt angles, respectively. It can be understood that the fact that a difference between angles of arrival is smaller than the threshold corresponds to the fact that the N wireless devices 20-1, . . . , 20-N are evenly distributed in a plurality of cells formed by the base station device 10-m.

On the other hand, when the difference is greater than or equal to the threshold, the tilt angle determination unit 232 determines a tilt angle based on at least one of the estimated P angles of arrival. In this case of this example, the tilt angle determination unit 232 determines the P estimated angles of arrival as P tilt angles, respectively.

The base station device 10-m of the first modified example of the embodiment also allows for effects and advantages similar to those of the base station device 10-m of the embodiment.

Furthermore, the base station device 10-m of the first modified example of the embodiment estimates P angles of arrival based on the signals received from the N wireless devices 20-1, . . . , 20-N. Furthermore, when a difference between angles of arrival of P estimated angles of arrival is smaller than a predetermined threshold, the base station device 10-m controls tilt angles to be predetermined reference angles. On the other hand, when the difference is greater than or equal to the threshold, the base station device 10-m controls tilt angles based on at least one of the plurality of estimated angles of arrival.

A plurality of areas where the N wireless devices 20-1, . . . , 20-N are densely located may often be located close to each other. In this case, control of tile angles based on angles of arrival would lead to too close directions of a plurality of beams. As a result, since radio signals are likely to interfere with each other between wireless areas (cells in this example), the communication quality may decrease.

In contrast, according to the base station device 10-m of the first modified example of the embodiment, P angles of arrival are estimated and, when a difference between angles of arrival of P estimated angles of arrival is smaller than a threshold, the tilt angle is controlled to be a reference angle. Therefore, it is possible to suppress directions of a plurality of beams from being too close to each other. This can suppress interference between radio signals between wireless areas. This can enhance the communication quality.

### Second Modified Example of the Embodiment

Next, a base station device of the second modified example of the embodiment will be described. The base station device of the second modified example of the embodiment is different from the base station device of the embodiment in that a tilt angle of a beam which forms the outermost cell is maintained fixed. This difference will be mainly described below. Note that, in the description of the second modified example of the embodiment, elements labeled with the same reference numerals as those in the embodiment represent the same or substantially the same elements as illustrated in the embodiment.

The angle of arrival estimation unit 231 of the second modified example of the embodiment estimates P angles of arrival different from each other based on the acquired received power characteristics. In this example, the number P is an integer greater than or equal to 2. For example, the angle of arrival estimation unit 231 acquires P angles at which received power is the maximum in the acquired received power characteristics in the order from an angle of the greater maximum value and estimates the acquired P angles as P angles of arrival, respectively.

The tilt angle determination unit 232 of the second modified example of the embodiment maintains (that is, does not change) a tilt angle of a beam having the smallest tilt angle of the P beams to a fixed value. In this example, the tilt angle of the beam having the smallest tilt angle of the P beams forms the farthest cell from the base station device 10-m (that is, the outermost cell) of the plurality of cells respectively formed by the P beams.

The tilt angle determination unit 232 changes respective tilt angles of other beams (that is, beams other than the beam having the smallest tilt angle) of the P beams based on the P angles of arrival estimated by the angle of arrival estimation unit 231. For example, the tilt angle determination unit 232 determines P minus 1 angles of arrival other than the smallest angle of arrival of the P estimated angles of arrival as P minus 1 beam tilt angles of the remaining beams other than the beam having the smallest tile angle of the P beams, respectively.

In this example, the vertical direction weight processing unit 210-1 forms a beam forming the outermost cell. In this example, the vertical direction weight processing unit 210-1 uses weight coefficients corresponding to a predetermined reference tilt angles. Therefore, in this example, the vertical direction weight processing unit 210-1 may not use weight coefficients determined by the vertical direction weight control unit 230.

The base station device 10-m of the second modified example of the embodiment allows for effects and advantages similar to those of the base station device 10-m of the embodiment.

Furthermore, the base station device 10-m of the second modified example of the embodiment maintains a tilt angle of a beam having the smallest tilt angle of the P beams and changes respective tilt angles of other beams of the P beams.

According to the above, the tilt angle of a beam forming the outermost wireless area of the wireless areas (cells in this example) formed by the base station device 10-m is maintained fixed. This can suppress interference of radio signals between the outermost wireless area of the wireless areas formed by the base station device 10-m and wireless areas formed by another base station device 10-s. The number s is an integer different from m of integers from 1 to M. Further, it is possible to suppress that a gap between the outermost wireless area of a wireless area formed by the base station device 10-m and a wireless area formed by another base station device 10-s becomes too wide.

### Third Modified Example of the Embodiment

Next, a base station device of the third modified example of the embodiment will be described. The base station device of the third modified example of the embodiment is different from the base station device of the second modified example of the embodiment in that a tilt angle is restricted to a value within a predefined range. This difference will be mainly described below. Note that, in the description of the third modified example of the embodiment, elements labeled with the same reference numerals as those in the embodiment represent the same or substantially the same elements as illustrated in the second modified example of the embodiment.

The angle of arrival estimation unit 231 of the third modified example of the embodiment estimates P angles of arrival different from each other based on the acquired received power characteristics. In this example, the number P is an integer greater than or equal to 2. In this example, the angle of arrival estimation unit 231 estimates P angles of arrival included in P angle ranges, respectively. The P angle ranges are angle ranges that are predefined and do not overlap with each other.

For example, the tilt angle determination unit 232 estimates, as angles of arrival, angles at which received power is maximum in respective P angle ranges in the acquired received power characteristics.

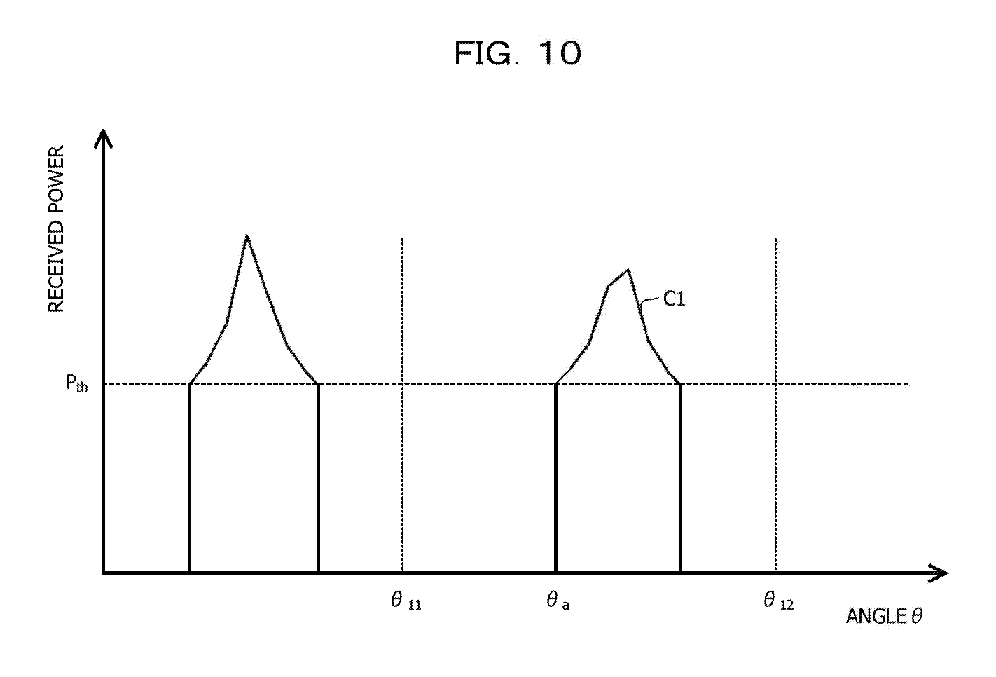

Note that, for example, as illustrated in FIG. 10, when received power is less than or equal to a predetermined reference power Pₜₕ, the angle of arrival estimation unit 231 may correct the acquired received power characteristics to be zero. In this case, for example, the angle of arrival estimation unit 231 may estimate, as an angle of arrival, the smallest angle which makes received power larger than zero in each of the P angle ranges in the corrected received power characteristics. For example, when an angle range is from an angle θ₁₁ to an angle θ₁₂ in the received power characteristics illustrated in FIG. 10, the angle of arrival estimation unit 231 may estimate an angle θₐ as an angle of arrival.

Note that, when there is no angle at which received power is larger than zero in an angle range, the angle of arrival estimation unit 231 may estimate a predetermined angle included in the angle range as an angle of arrival.

The tilt angle determination unit 232 of the third modified example of the embodiment maintains (that is, does not change) a tilt angle of a beam having the smallest tilt angle of the P beams to a fixed value. In this example, a beam having the smallest tilt angle of the P beams forms the farthest cell (or the outermost cell) from the base station device 10-m of a plurality of cells formed by respective P beams.

The tilt angle determination unit 232 changes respective tilt angles of other beams (that is, beams other than the beam having the smallest tilt angle) of the P beams based on the P angles of arrival estimated by the angle of arrival estimation unit 231. For example, the tilt angle determination unit 232 determines P minus 1 angles of arrival other than the smallest angle of arrival of the P estimated angles of arrival as tilt angles of P minus 1 beams other than the beam having the smallest tilt angle, respectively.

In this example, the vertical direction weight processing unit 210-1 forms a beam forming the outermost cell. In this example, the vertical direction weight processing unit 210-1 uses weight coefficients corresponding to predefined reference tilt angles. Therefore, in this example, the vertical direction weight processing unit 210-1 may not use weight coefficients determined by the vertical direction weight control unit 230.

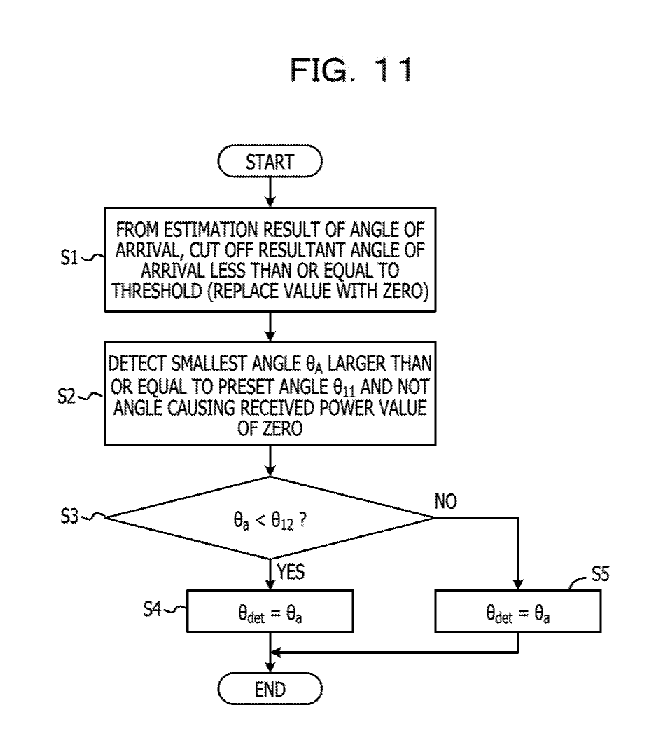

An angle of arrival estimation process performed by the base station device 10-m of the third modified example of the above embodiment will be described by using a flowchart (steps S1 to S5) illustrated in FIG. 11.

From an estimation result of the angle of arrival, the angle of arrival estimation unit 231 cuts off a resultant angle of arrival which is less than or equal to a threshold (step S1). In other words, the angle of arrival estimation unit 231 replaces a received power value which is less than or equal to the threshold with zero.

The angle of arrival estimation unit 231 detects the smallest angle θₐ that is larger than or equal to a preset angle θ₁₁ and not an angle causing a received power value of zero (step S2).

The angle of arrival estimation unit 231 determines whether or not the angle θₐ is smaller than a preset angle θ₁₂ (step S3).

When the angle θₐ is smaller than the preset angle θ₁₂ (see step S3, Yes), the angle of arrival estimation unit 231 estimates that the angle of arrival θ_{det} of a received signal from the wireless device 20-n is the angle θₐ (step S4). The process then ends.

On the other hand, when the angle θₐ is not smaller than the preset angle θ₁₂ (see step S3, No), the angle of arrival estimation unit 231 estimates that the angle of arrival θ_{det} of a received signal from the wireless device 20-n is the angle θ₁₂ (step S5). The process then ends.

The base station device 10-m of the third modified example of the embodiment allows for effects and advantages similar to those of the base station device 10-m of the second modified example of the embodiment.

Furthermore, the base station device 10-m of the third modified example of the embodiment restricts a tilt angle to a value within a predefined range.

According to the above, even when a tilt angle is changed, it is possible to suppress interference of radio signals between the outermost wireless area of the wireless areas (cells in this example) formed by the base station device 10-m and a wireless area formed by another base station device 10-s. Further, even when a tilt angle is changed, it is possible to suppress that a gap between the outermost wireless area of the wireless areas formed by the base station device 10-m and a wireless area formed by another base station device 10-s becomes too wide.

Furthermore, even when a tilt angle is changed, it is possible to suppress interference of radio signals between wireless areas formed by the base station device 10-m. Further, even when a tilt angle is changed, it is possible to suppress a gap between wireless areas formed by the base station device 10-m from being too wide.

### Fourth Modified Example of the Embodiment

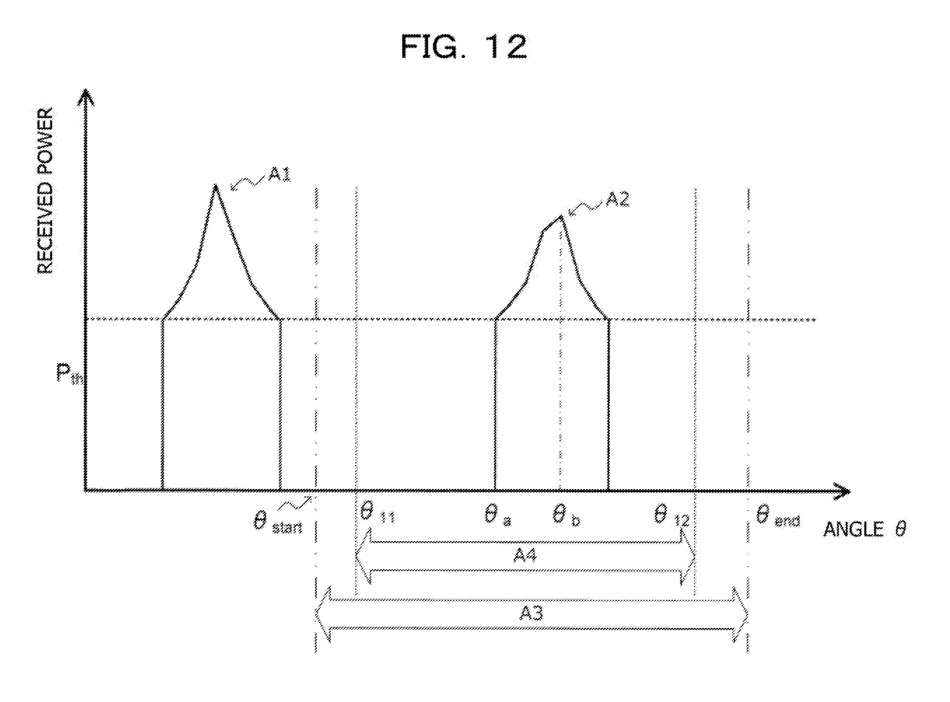

Next, the base station device 10-m of the fourth modified example of the embodiment will be described. In contrast to the base station device 10-m of the embodiment, the base station device 10-m of the fourth modified example of the embodiment calculates the centroid of received signal characteristics that are obtained by received signals from a plurality of wireless devices 20-1, . . . , 20-N and estimates an angle of arrival based on the calculation result. Calculation of the centroid may be performed by correcting received signal characteristics such that power is corrected to zero when the power of a received signal is less than or equal to a reference value and estimating the angle of arrival based on the corrected received signal characteristics (see FIG. 12).

FIG. 12 is a graph illustrating a first example of an angle of arrival estimation process performed by the base station device 10-m of the fourth modified example of the embodiment. In FIG. 12, the horizontal axis represents an angle θ, which is the angle of an arrival direction of a received signal from the wireless device 20-n relative to the horizontal plane (hereafter, also referred to as “angle of arrival 0”), and the vertical axis represents the received power of the received signal.

In the graph illustrated in FIG. 12, A1 represents a received signal from the wireless device 20-n in an outer cell, and A2 represents a received signal from the wireless device 20-n in an inner cell.

In the third modified example of the embodiment described above, the angle of arrival estimation unit 231 detects the angle θₐ depicted in FIG. 12. As illustrated in FIG. 12, however, the received power from the wireless devices 20-n is concentrated in a direction indicated by an angle θ_{b}. Thus, the angle of arrival estimation unit 231 may estimate a direction around the angle θ_{b} as the angle of arrival.

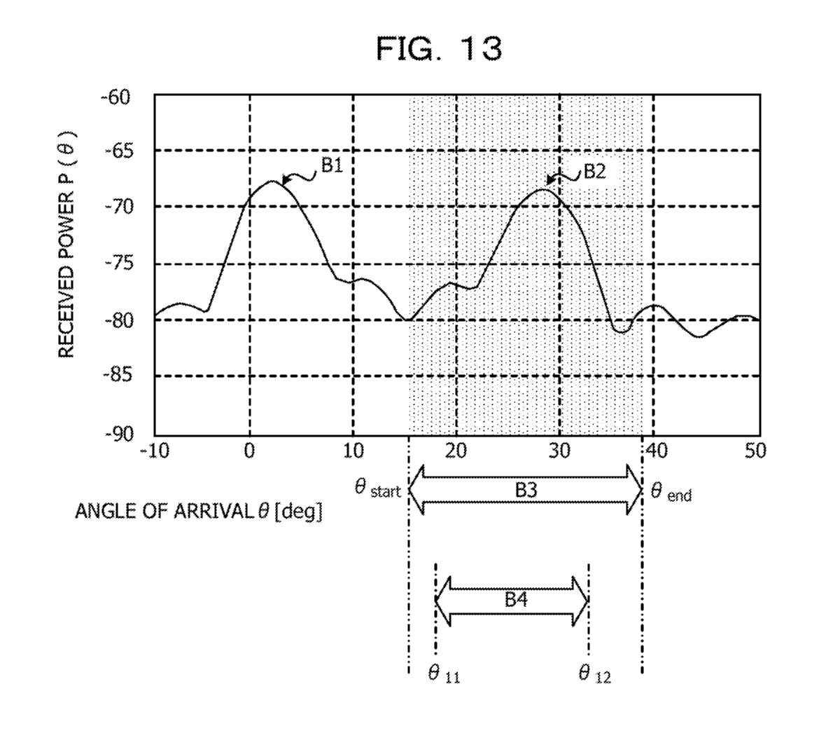

FIG. 13 is a graph illustrating a second example of an angle of arrival estimation process performed by the base station device 10-m of the fourth modified example of the embodiment. In FIG. 13, the horizontal axis represents an angle e, which is the angle of an arrival direction of a received signal from the wireless device 20-n relative to a horizontal plane (hereafter, also referred to as “angle of arrival θ”), and the vertical axis represents the received power P(θ) of the received signal. Note that the unit of an angle of arrival is degree.

In the graph illustrated in FIG. 13, B1 represents a received signal from the wireless device 20-n in an outer cell, and B2 represents a received signal from the wireless device 20-n in an inner cell.

The angle of arrival estimation unit 231 may estimate the angle of arrival θ based on the received power P(θ) in which received power within a range less than or equal to a predetermined reference value Pₜₕ is corrected to zero as seen in the graph illustrated in FIG. 12. Further, the angle of arrival estimation unit 231 may estimate the angle of arrival θ based on the received power P(θ) in which received power within a range less than or equal to a predetermined reference value Pₜₕ is not corrected to zero as seen in the graph illustrated in FIG. 13.

When the received power P(θ) is corrected, the following Equation 1 is established.

$$P ( θ ) = \{ \begin{matrix}0 & P ( θ ) < {P}_{th} \\ P ( θ ) & P ( θ ) \geq {P}_{th}\end{matrix} \qquad Equation 1$$

When correcting received power within a range less than or equal to the predetermined reference value Pₜₕ to zero, the angle of arrival estimation unit 231 uses a result of Equation 1 to calculate the centroid θₜₘₚ within a range from an angle of arrival θₛₜₐᵣₜ to an angle of arrival θ_{end} in FIG. 12 (see A3 of FIG. 12). Further, when not correcting received power within a range less than or equal to the predetermined reference value Pₜₕ to zero, the angle of arrival estimation unit 231 calculates the centroid θₜₘₚ within a range from the angles of arrival θₛₜₐᵣₜ to the angle of arrival θ_{end} hatched in FIG. 13 (see B3 of FIG. 13). In both cases, the centroid θₜₘₚ may be calculated by using the following Equation 2.

$${θ}_{tmp} = {\sum }_{θ = {θ}_{start}}^{{θ}_{end}} P ( θ ) \cdot θ / {\sum }_{θ = {θ}_{start}}^{{θ}_{end}} P ( θ ) \qquad Equation 2$$

The angle of arrival estimation unit 231 then calculates the angle of arrival θ_{det} limited within a range from a predefined angle θ₁₁ to a predefined angle θ₁₂ (see A4 of FIGS. 12 and B4 of FIG. 13). The angle of arrival θ_{det} may be calculated by using the following Equation 3.

$${θ}_{det} = \{ \begin{matrix}{θ}_{11} & {θ}_{tmp} < {θ}_{11} \\ {θ}_{tmp} & {θ}_{11} \leq {θ}_{tmp} \leq {θ}_{12} \\ {θ}_{12} & {θ}_{12} < {θ}_{tmp}\end{matrix} \qquad Equation 3$$

The angle θ₁₁ may be the largest angle by which, when a beam is directed to a particular direction, a region where no signal is received by any wireless device 20-n does not occur between the beam and another beam directed to a neighboring cell (hereafter, such a region may be referred to as “insensitive region”). Further, the angle θ₁₂ may be the smallest angle by which, when a beam is directed to a particular direction, no insensitive region occurs between the beam and another beam directed to a neighboring cell.

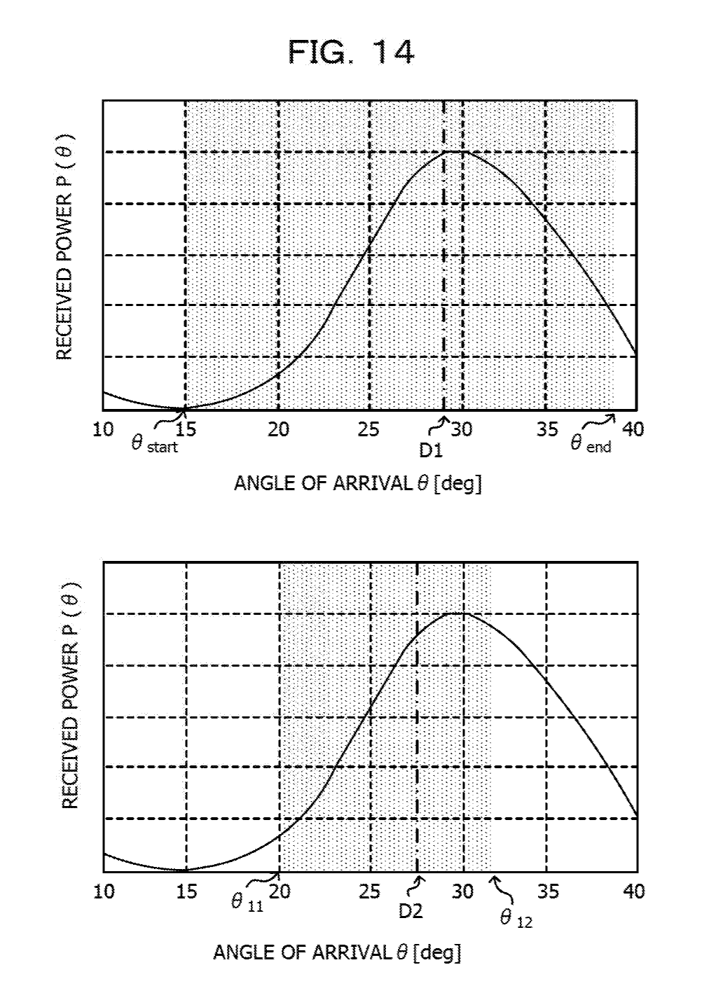

Graph (1) of FIG. 14 is a graph illustrating an example of the centroid position of received power when a calculation range of the centroid is larger than a control range of the tilt angle. Graph (2) of FIG. 14 is a graph illustrating an example of the centroid position of received power when a calculation range of the centroid is the same as a control range of the tilt angle. In graphs (1) and (2) of FIG. 14, the horizontal axis represents an angle θ, which is the angle of a received signal from the wireless device 20-n relative to a horizontal plane (hereafter, also referred to as “angle of arrival θ”), and the vertical axis represents the received power P(θ) of the received signal. Note that the unit of an angle of arrival is degree.

Graphs (1) and (2) of FIG. 14 illustrate an example in which the centroid θₜₘₚ is calculated based on the received power P(θ) in which received power within a range less than or equal to the predetermined reference value Pₜₕ is not corrected to zero.

For example, as illustrated in graph (2) of FIG. 14, the calculation result of the centroid θₜₘₚ is around 27 degrees when P(θ) expands wider in the θ direction over a range from θ₁₁ (for example, 20 degrees) to θ₁₂ (for example, 32 degrees) that is intended to eventually control (see D2).

On the other hand, as illustrated in graph (1) of FIG. 14, the calculation result of the centroid θₜₘₚ is around 29 degrees in a range from θₛₜₐᵣₜ (for example, 15 degrees) to θ_{end} (for example, 39 degrees) that is wider than the range from θ₁₁ to θ₁₂ intended to eventually control (see D1).

In comparison of graph (1) of FIG. 14 and graph (2) of FIG. 14, the case of graph (1) of FIG. 14 allows the beam direction to be controlled closer to the peak of the received power P(e) and thus the beam can be controlled in a more appropriate direction.

In such a way, when calculating the centroid based on corrected received signal characteristics (see FIG. 12) or on not-corrected received signal characteristics (see FIG. 13), the angle of arrival estimation unit 231 may increase a calculation range (from θₛₜₐᵣₜ to θ_{end}) of the centroid θₜₘₚ wider than a control range (θ₁₁ to θ₁₂) of the tilt angle of an inner cell intended to eventually control. Note that, when calculating the centroid based on any of the received signal characteristics (see FIG. 12 and FIG. 13), the angle of arrival estimation unit 231 may calculate the centroid θₜₘₚ of received power in a control range (from θ₁₁ to θ₁₂) of the tilt angle of an inner cell intended to eventually control.

The angle of arrival estimation unit 231 may further correct a calculation result obtained by using the centroid θₜₘₚ such that an estimation result of an angle of arrival corresponds to a peak value of the received power P(θ). Thereby, it is possible to match an estimated direction of an angle of arrival to a peak of received power.

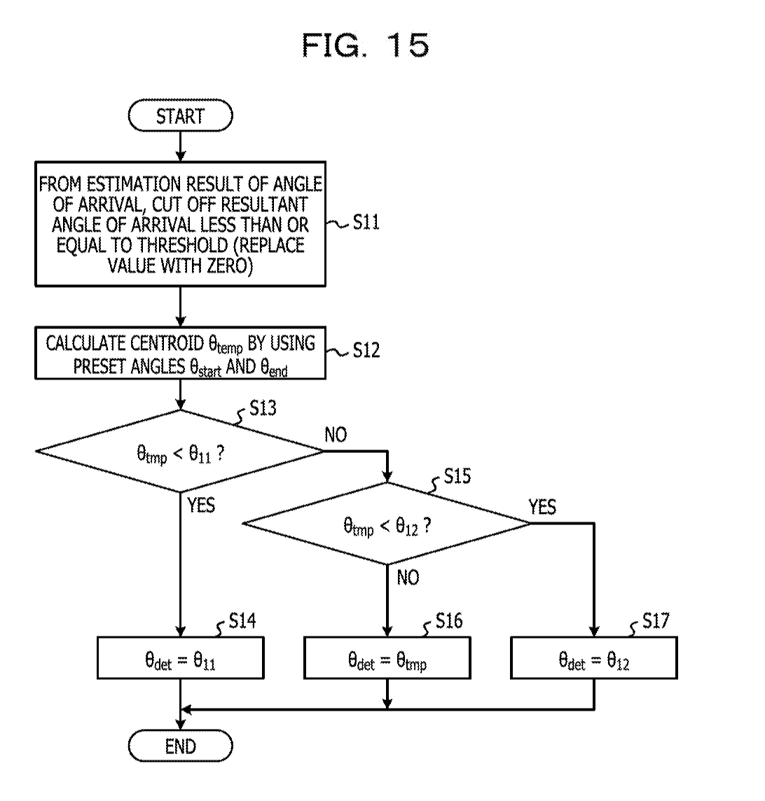

An angle of arrival estimation process performed by the base station device 10-m of the fourth embodiment of the embodiment described above will be described by using a flowchart (steps S11 to S17) illustrated in FIG. 15 with respect to a process in which a centroid is calculated based on corrected received signal characteristics, for example.

From an estimation result of the angle of arrival, the angle of arrival estimation unit 231 cuts off a resultant angle of arrival which is less than or equal to a threshold (step S11). In other words, the angle of arrival estimation unit 231 replaces a received power value which is less than or equal to the threshold with zero.

The angle of arrival estimation unit 231 calculates the centroid θₜₘₚ by using the preset angles θₛₜₐᵣₜ and θ_{end} (step S12).

The angle of arrival estimation unit 231 determines whether or not the centroid θₜₘₚ is smaller than the preset angle θ11 (step S13).

When the centroid θₜₘₚ is smaller than the preset angle θ₁₁ (see step S13, Yes), the angle of arrival estimation unit 231 estimates that the angle of arrival θ_{det} of a received signal from the wireless device 20-n is the angle θ₁₁ (step S14). The process then ends.

On the other hand, when the centroid θₜₘₚ is not smaller than the preset angle θ₁₁ (see step S13, No), the angle of arrival estimation unit 231 determines whether or not the centroid θₜₘₚ is larger than the preset angle θ₁₂ (step S15).

When the centroid θₜₘₚ is not larger than the preset angle θ₁₂ (see step S15, No), the angle of arrival estimation unit 231 estimates that the angle of arrival θ_{det} of a received signal from the wireless device 20-n is the centroid θₜₘₚ (step S16). The process then ends.

On the other hand, when the centroid θₜₘₚ is larger than the preset angle θ₁₂ (see step S15, Yes), the angle of arrival estimation unit 231 estimates that the angle of arrival θ_{det} of a received signal from the wireless device 20-n is the angle θ₁₂ (step S17). The process then ends.

Note that, when the centroid is calculated based on the not-corrected received signal characteristics, the process of step S11 in the flowchart of FIG. 15 can be skipped or omitted.

The base station device 10-m of the fourth modified example of the embodiment allows for the following effects and advantages, in addition to the effects and advantages similar to those of the base station device 10-m of the third modified example of the embodiment.

That is, since the base station device 10-m of the fourth modified example of the embodiment calculates the centroid of received signal characteristics or corrected received signal characteristics obtained from received signals from a plurality of wireless devices 20-n and estimates the angle of arrival based on the calculation result, an angle of arrival closer to an angle at which received power becomes peak can be estimated.

Further, since a calculation range of the centroid is set wider than a predefined control range of the tilt angle, an angle of arrival that is closer to an angle at which received power becomes peak can be estimated compared to a case where a calculation range of the centroid is a control range of the tilt angle.

### Fifth Modified Example of the Embodiment

Next, a base station device of the fifth modified example of the embodiment will be described. The base station device of the fifth modified example of the embodiment is different from the base station device of the embodiment in that a tilt angle is controlled based on a previous tilt angle. This difference will be mainly described below. Note that, in the description of the fifth modified example of the embodiment, elements labeled with the same reference numerals as those of the embodiment represent the same or substantially the same elements as illustrated in the embodiment.

The tilt angle determination unit 232 of the fifth modified example of the embodiment stores a determined tilt angle every time the tilt angle is determined. In this example, determination of a tilt angle is performed based on an angle of arrival estimated by the angle of arrival estimation unit 231 and a stored tilt angle.

For example, the tilt angle determination unit 232 averages the latest R-1 tilt angles of stored tilt angles and an angle of arrival estimated by the angle of arrival estimation unit 231 and determines the averaged value as a current tilt angle. The number R is an integer greater than or equal to 2. Note that an average may be a moving average, a block average, an obliteration average, or the like.

The base station device 10-m of the fifth modified example of the embodiment allows for effects and advantages similar to those of the base station device 10-m of the embodiment.

Furthermore, the base station device 10-m of the fifth modified example of the embodiment controls a tilt angle based on a previous tilt angle.

The signals received from the N wireless devices 20-1, . . . , 20-N may include a noise. Thus, an estimated angle of arrival is likely to vary due to a noise. Therefore, a tilt angle determined based on an estimated angle of arrival may be unable to properly reflect an angle of the horizontal plane relative to a direction toward an area where the N wireless devices 20-1, . . . , 20-N are densely located.

In contrast, according to the base station device 10-m, a tilt angle is controlled based on a previous tilt angle. Therefore, a tilt angle can be controlled to be a value that accurately reflects an angle of the horizontal plane relative to a direction toward an area where the N wireless devices 20-1, . . . , 20-N are densely located. This can suppress interference of radio signals between wireless areas (cells in this example). This can enhance the communication quality.

Others

While an angle of arrival of a received signal from the wireless device 20-n is estimated by calculating the centroid of the received power in the fourth modified example of the embodiment described above, estimation is not limited thereto. For example, an angle at which the received power becomes peak may be estimated as an angle of arrival. Thereby, it is possible to match an estimation direction of the angle of arrival to the peak of received power.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A base station comprising:
a memory; and
a processor coupled to the memory and the processor configured to:
estimate a plurality of angles of arrival based on a plurality of received signals from a plurality of wireless device respectively, each of the plurality of angles of arrival being an angel of a horizontal plane relative to each direction from which each of the plurality of received signals arrives; and
control at least one tilt angel based on the plurality of angels of arrival, each of the at least one tilt angle being an angle of the horizontal plane relative to each direction to which at least one beam is formed.

2. The base station according to claim 1, wherein
the at least one beam includes a plurality of beams,
the at least one tilt angel includes a plurality of tilt angels respectively corresponding to the plurality of beams, and
the processor is configured to maintain a specified tilt angle that is the smallest in the plurality of tilt angels, and change the plurality of tilt angels other than the specified tilt angle.

3. The base station according to claim 1, wherein
the processor is configured to restrict the at least one tilt angel within a specified range.

4. The base station according to claim 1, wherein
each of the plurality of angles of arrival is estimated based on each change in a received power of each of the plurality of received signals received from a specified direction with respect to an angle between the specified direction and the horizontal plane.

5. The base station according to claim 1, wherein
the processor is configured to control the at least one tilt angel to a reference angle when a difference among the plurality of angles of arrival is smaller than a specified threshold, and control the at least one tilt angel based on at least one of the plurality of angles of arrival when the difference is greater than or equal to the specified threshold.

6. The base station according to claim 1, wherein
the processor is configured to correct each characteristic of the plurality of received signals, when each received power of the plurality of received signals is smaller than or equal to a specified value, so that each received power is to be zero, and
each of the plurality of angles of arrival is estimated based on each corrected characteristic of the plurality of received signals.

7. The base station according to claim 6, wherein
the processor is configured to estimate each of the plurality of angles of arrival to be the smallest angle whose received power is greater than or equal to zero in each corrected characteristic.

8. The base station according to claim 6, wherein
the processor is configured to estimate each of the plurality of angles of arrival based on each centroid position of each corrected characteristic.

9. The base station according to claim 8, wherein
a range for calculating each centroid position is wider than a range for controlling the at least one tilt angel.

10. The base station according to claim 1, wherein
the processor is configured to estimate each of the plurality of angles of arrival based on each centroid position of each characteristic.

11. The base station according to claim 10, wherein
a range for calculating each centroid position is wider than a range for controlling the at least one tilt angel.

12. The base station according to claim 6, wherein
the processor is configured to estimate each of the plurality of angles of arrival to be each peak value of each received power of the plurality of received signals in each corrected characteristic of the plurality of received signals.

13. The base station according to claim 1, wherein
each of the at least one tilt angel is controlled based on each previous tilt angel of the at least one tilt angel.

14. A communication control method comprising:
estimating a plurality of angles of arrival based on a plurality of received signals from a plurality of wireless device respectively, each of the plurality of angles of arrival being an angel of a horizontal plane relative to each direction from which each of the plurality of received signals arrives; and
controlling at least one tilt angel based on the plurality of angels of arrival, each of the at least one tilt angle being an angle of the horizontal plane relative to each direction to which at least one beam is formed.
